(19) United States
(12) Patent Application Publication
(10) Pub. No.: US 2010/0064083 A1
(43) Pub. Date: Mar. 11, 2010

(54) COMMUNICATIONS DEVICE WITHOUT PASSIVE PULLUP COMPONENTS

(75) Inventors: Philip S. Ng, Cupertino, CA (US); Jinshu Son, Saratoga, CA (US)

Correspondence Address: SCHWEGMAN, LUNDBERG & WOESSNER / ATMEL, P.O. BOX 2938, MINNEAPOLIS, MN, 55402, US

(73) Assignee: Atmel Corporation

(21) Appl. No.: 12/619,545

(22) Filed: Nov. 16, 2009

Related U.S. Application Data
(63) Continuation of application No. 11/379,872, filed on Apr. 24, 2006.

(51) Int. Cl. G06F 13/00

(52) U.S. Cl. 710/110

(57) ABSTRACT

A dual-wire communications bus circuit, compatible with existing two-wire protocols, includes a first and second part of the communications bus circuit to couple to a communications bus. The bus has a first line for carrying data signals from a master device to a slave device and a second line to carry a clock signal between the devices. To improve data throughout and reduce noise, an active pullup device is located in at least one part of the communications bus circuit, the active pullup device in the first part of the of the communications bus circuit couples to the first line and an optional active pullup device in the second part couples to the second line of the communications bus. Each active pullup device may provide a high logic level on one of the communications bus lines.

### RELATED APPLICATIONS

This application is a continuation of U.S. patent application Ser. No. 11/379,872, filed on Apr. 24, 2006, which is incorporated herein by reference in its entirety.

### TECHNICAL FIELD

Embodiments of the invention relate to a bus architecture for transferring information between electronic devices, including a dual-wire bus architecture.

### BACKGROUND

Many similarities exist between seemingly unrelated designs in consumer, industrial, and telecommunication electronics. Examples of similarities include intelligent control, general-purpose circuits (e.g., LCD drives and I/O ports) and application-oriented circuits. One prior art two-wire bus is a bi-directional two-wire, low to medium speed, serial communication bus designed to exploit such similarities in electrical circuits. The two-wire bus was developed in the early 1980s and was created to reduce manufacturing costs of electronic products.

Prior to the two-wire bus, chip-to-chip communications used a large plurality of pins in a parallel interface. Many of these pins were used for chip-to-chip addressing, selection, control, and data transfers. For example, in a parallel interface, eight data bits are typically transferred from a sender integrated circuit (IC) to a receiver IC in a single operation. The two-wire bus performs chip-to-chip communications using two wires in a serial interface, allowing ICs to communicate with fewer pins. The two wires in the bus carry addressing, selection, control, and data, serially, one bit at a time. A data (SDA) wire carries the data, while a clock (SCL) wire synchronizes the sender and receiver during the transfer. ICs utilizing the two-wire bus can perform similar functions to their larger parallel interface counterparts, but with far fewer pins.

Two-wire bus devices are classified as master or slave. A device that initiates a message is called a master (multiple masters are possible), while a device that responds to a message is called a slave (multiple slaves are also possible). A device can potentially be master, slave, or switch between master and slave, depending on a particular device and application. Hence, the device may at one point in time be a master while the device later takes on a role as slave. The two-wire bus can connect a plurality of ICs using two-wires (SDA and SCL, described supra).

Contemporary two-wire slave devices maintain a unique address. Therefore, part of a two-wire protocol requires a slave address at the beginning of a message. (Two-wire protocol specifications are well known. See, for example, U.S. Published Patent Application 2002/0176009 to Johnson et al. entitled “Image Processor Circuits, systems, and Methods.”) Consequently, all devices on the two-wire bus hear the message, but only the slave that recognizes its own address communicates with the master. Devices on the two-wire bus are typically accessed by individual addresses, for example, 00-FF where even addresses are used for writes and odd addresses are used for reads.

Since two-wire buses can connect a number of devices simultaneously to the same pair of bus wires, a problem results when one of the devices malfunctions and pulls a bus signal (clock or data) low; the bus becomes inoperative and a determination of which of the numerous devices connected to the two-wire bus is responsible becomes difficult. A similar problem occurs when one of the bus conductors becomes shorted to a low impedance source, such as, for example, a ground potential.

FIG. 1 is a prior art example of a practical application of a two-wire bus. FIG. 1 includes a digital signal processor (DSP) 115 (here, the DSP 115 functions as a master device). External pins of the DSP 115 are a bidirectional data pin (SDA) and a serial clock (SCL) pin, both of which are coupled to various slave devices 107, 109 on the two-wire bus via a serial data line 103 and a serial clock line 105. Both the serial data line 103 and the serial clock line 105 are connected respectively via a first 111 and second 113 external pull-up resistor to a positive supply voltage V_{DD} on a power supply line 101. When the two-wire bus is free, the serial data line 103 is at logic HIGH. Output stages of the slave devices 107, 109 connected to the two-wire bus typically have an open-drain or open-collector in order to perform a wired-OR function. Data on the contemporary prior art two-wire bus is transferred at a rate of up to 400 kbits/sec in fast mode. According to the two-wire specification, the number of interfaces to the bus is dependent, in part, to limiting bus capacitance to 400 picofarads.

With reference to FIG. 2, another prior art application of a two-wire bus includes a microcontroller 201 with two of the I/O pins used for clock (“CLK”) and data (“DATA”) signals coupled to a first serial EEPROM memory device 203A and an eighth serial EEPROM memory device 203H. Up to eight serial EEPROM devices may share a two-wire bus 205 under the two-wire protocol (partially described herein), utilizing the same two microcontroller CLK and DATA I/O pins. Each serial EEPROM device must have its own address inputs (A₀, A₁, and A₂) hard-wired to a unique address to be accessible. With continued reference to FIG. 2, the first serial EEPROM device 203A recognizes address zero (“0”) (A₀, A₁, and A₂ are all tied LOW) while the eighth serial EEPROM device 203H recognizes address seven (“7”) (A₀, A₁, and A₂ are all tied HIGH). The serial EEPROM devices 203A . . . 203H are slave devices, receiving or transmitting data received on the two-wire bus 205 in response to orders from a master device; here, the microcontroller 201 is the master device.

The microcontroller 201 initiates a data transfer by generating a start condition on the two-wire bus 205. This start condition is followed by a byte containing the device address of the intended EEPROM device 203A . . . 203H. The device address consists of a four-bit fixed portion and a three-bit programmable portion. The fixed portion must match a value hard-wired into the slave, while the programmable portion allows the microcontroller 201, acting as master, to select between a maximum of eight slaves on the two-wire bus 205. An eighth bit specifies whether a read or write operation will occur.

The two-wire bus 205 is tied to V_{DD} through a clock line weak resistor 207 and a data line weak resistor 209. If no device is pulling the two-wire bus 205 to ground, the bus 205 will be pulled up by the weak resistors 207, 209 indicating a logic “1” (HIGH). If the microcontroller 201 or one of the EEPROM memory device 203A . . . 203H slaves pulls the bus 205 to ground, the bus will indicate a logic “0” (LOW).

However, despite a widespread us of the two-wire bus, the bus suffers from numerous drawbacks. For example, the two-wire bus is noisy, requiring a noise suppression circuit to filter noise when data are present on the bus. The noise suppression circuit reduces EEPROM device I/O speed. Further, when an EEPROM device outputs a logic “1” onto the two-wire bus, the device relies on the weak resistor to pull up the bus. Therefore, a data transfer rate is limited by the strength of the weak resistor 209 due to an increased RC time constant. If a stronger resistor is employed, a stronger pulldown device is required thus consuming more current to output a logic “0” onto the bus.

Therefore, what is needed is a dual-wire bus that is usable with contemporary communication specifications and protocols that produces less noise and is capable of higher data transfer rates.

### SUMMARY

Embodiments of present invention achieve a high speed data transfer rate through a use of at least one active pullup device. The at least one active pullup device serves to reduce a time required due to the RC time constant and minimizes noise, both due primarily to the pullup resistor operating independently in the prior art. However, system designers using the embodiments of the present invention may still utilize some of the existing two-wire protocols, specifications, and existing software.

An example embodiment of the present invention is a dual-wire communications bus circuit, compatible with many existing two-wire bus specifications. Existing specifications that include a first line of a communications bus, where the first line carries data signals from a master device to a slave device, and a second line of the communications bus, where the second line carries clock signals from the master device to the slave device may also be compatible. Pullup resistors of the prior art are eliminated and are replaced by one or more active devices. In this embodiment, a cascade of slave devices (e.g., EEPROM memory devices) may be replaced by a single device. For example, a single high density memory device could take the place of several smaller individual memory devices. Consequently, addressing pins would not be needed on the slave device (e.g., the memory device) and yet the communication protocol is still usable—the three bit address location is replaced with “don't care” bits.

Another example embodiment of the present invention is a dual-wire communications bus circuit, which includes a portion of the communications bus circuit being configured to couple to a first line of a dual-wire communications bus. The first line is capable of carrying data signals from a master device to a slave device. An active pullup device is located in the portion of the communications bus circuit and is capable of producing and maintaining a high logic level on the first line of the dual-wire communications bus line while not requiring a pullup resistor.

### BRIEF DESCRIPTION OF THE DRAWINGS

FIG. 1 is a two-wire bus of the prior art used in a digital signal processing application.

FIG. 2 is a two-wire bus of the prior art used in an application where a microcontroller accesses a plurality of memory devices.

FIG. 3A is an example application of a dual-wire bus of an embodiment of the present invention with a microcontroller accessing a high density serial EEPROM device and requiring no pullup resistor.

FIG. 3B is another example application of a dual-wire bus of an embodiment of the present invention with a microcontroller accessing a high density serial EEPROM device and requiring no pullup resistor.

FIG. 4 is a timing diagram comparing relative speeds of the dual-wire bus of an embodiment of the present invention with the prior art two-wire bus.

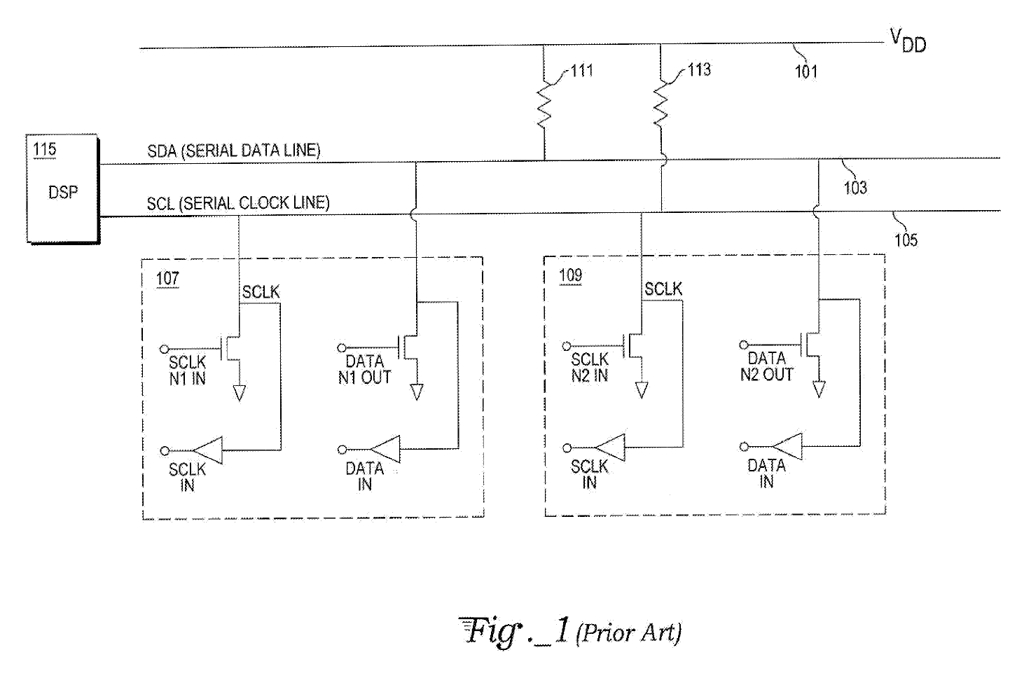

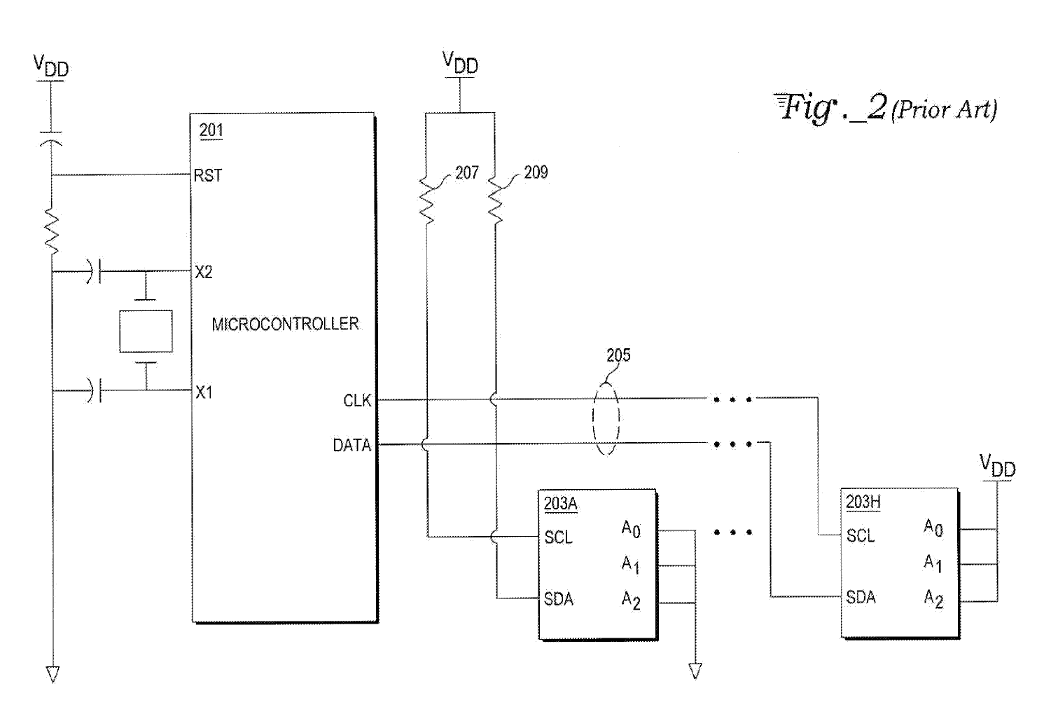

### DETAILED DESCRIPTION

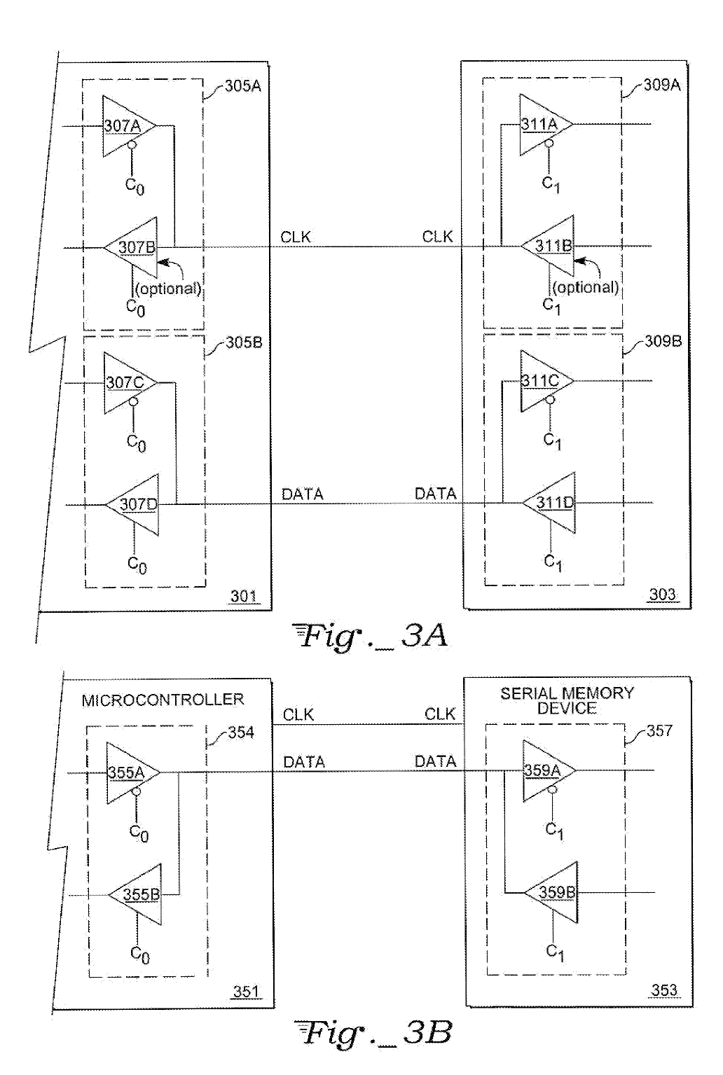

With reference to FIG. 3A, an example embodiment of a dual-wire bus system includes a microcontroller 301 and a high density serial memory device 303. (Note: As discussed infra, the microcontroller 301 and the high density serial memory device 303 could alternatively each be, for example, a microcontroller. In this case, there may be bidirectional communication where a first microcontroller is a slave while a second microcontroller is a master and later the master-slave relationship is reversed with regard to the two microcontrollers.) The serial memory device 303 may be, for example, an EEPROM memory device. The microcontroller 301 includes a pair of dual tristate output buffers 305A, 305B, driving the CLK and DATA lines, respectively. Each dual tristate output buffer 305A, 305B contains individual tristate buffers 307A, 307B, and 307C, 307D. The high density serial memory device 303 also includes a pair of dual tristate output buffers 309A, 309B, each of which contain individual tristate buffers 311A, 311B, and 311C, 311D. Note that the tristate buffers 307B, 311B (driving the clock line) from the high density serial memory device 303 back to the microcontroller 301 are optional for this example embodiment.

A first two of the individual tristate buffers 307A, 307C have an active low control whereas the other two tristate buffers 307B, 307D have an active high control, thus assuring the microcontroller 301 and the high density serial memory device 303 will not drive the data line or clock line at the same time (thereby eliminating “current fighting” or a possible extra pulse on the data line). Accordingly, each of the individual tristate buffers within the high density serial memory device 303 have a similar control scheme. In this case, two of the tristate buffers 311A, 311C have an active low control and the other two tristate buffers 311B, 311D have an active high control. Control lines (C₀, C₁ in FIGS. 3A and 3B) may be controlled by means known to one of skill in the art.

Since the microcontroller 301 or the high density serial memory device 303 may have a limited current driving capacity (e.g., approximately 5 mA or less), each of the tristate buffers 307A . . . 307D, 311A . . . 311D, provide a much higher current source since each is tied directly to V_{DD}. Therefore, the clock line in FIG. 3A, for example, may be driven with a higher current than would be possible with the current driving capability of the microcontroller 301 alone. In an alternative example embodiment of FIG. 3A, the microcontroller 301 may act as either a master or slave. In another embodiment, the high density serial memory device 303 may be replaced by another microcontroller that may act as a master or slave device.

With reference to FIG. 3B, an additional alternative example embodiment of a system utilizing a dual-wire bus circuit includes a microcontroller 351 and a high density serial memory device 353. In this embodiment, a current on the clock line is supplied entirely by the microcontroller 351. A dual tristate output buffer 354 of the microcontroller 351 contains an active low tristate buffer 355A and an active high tristate buffer 355B. The high density serial memory device 353 also has a dual tristate output buffer 357 which contains an active low tristate buffer 359A and an active high tristate buffer 359B. In a manner similar to FIG. 3A, supra, the active low control and the active high control tristate buffer configurations prevent driving the data line at the same time.

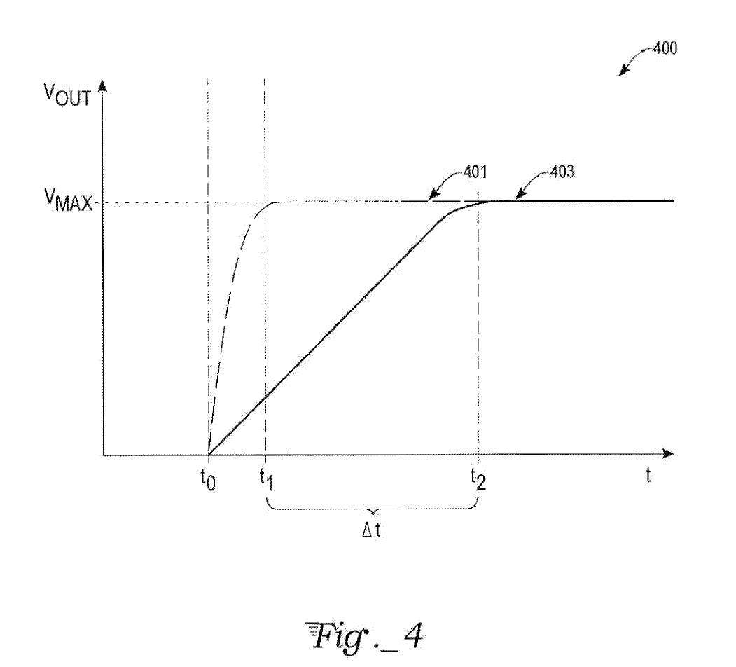

With reference to FIG. 4, a timing diagram 400 compares relative time constants of a two-wire bus of the prior art with a dual-wire bus of an embodiment of the present invention. A first curve 401 represents relative timing for the dual-wire bus while a second curve 403 represents relative timing for the two-wire bus of the prior art. From time t₀ to time t₁, the first curve 401 increases in voltage quickly due to one or more active pullup devices (for example, the pair of dual tristate buffers of FIG. 3A) being switched appropriately. For example, at time t₀, the active pullup device turns on and the voltage on one line of the dual-wire bus increases to Vₘₐₓ at t₁. A slope of the second curve 403 is due to the RC time constant of the prior art two-wire circuit where a pullup resistor is employed. Therefore, an overall time required to drive a line to logic “1” has been reduced significantly, by a time Δt, as a result of the active pullup circuit of an embodiment of the present invention.

In the foregoing specification, the embodiments of the present invention have been described with reference to specific embodiments thereof. For example, although active pullup devices described herein are defined in terms of tristate buffers, a skilled artisan will realize that other active devices, such as bipolar devices, may be readily implemented as well. It will, therefore, be evident that various modifications and changes can be made thereto without departing from the broader spirit and scope of the present invention as set forth in the appended claims. The specification and drawings are, accordingly, to be regarded in an illustrative rather than a restrictive sense.

What is claimed is:

1. An apparatus comprising:
a circuit to couple to a first line of a communication bus circuit, the first line to carry a data signal between a first device and a second device; and
an active pullup device located in the circuit to produce and maintain a signal level on the first line, the active pullup device including a first tristate buffer having an input, an output coupled to the first line, and a node to receive a control signal, the active pullup device further including a second tristate buffer having an input coupled to the first line, an output, and a node to receive the control signal.

2. The apparatus of claim 1, further comprising:
an additional circuit to couple to a second line of the communication bus circuit, the second line to carry a clock signal between the first and second devices; and
an additional active pullup device located in the additional circuit to produce and maintain a signal level on the second line.

3. The apparatus of claim 2, wherein the additional active pullup device includes a third tristate buffer having an input, an output coupled to the second line, and a node to receive the control signal.

4. The apparatus of claim 3, wherein the additional active pullup device includes a fourth tristate buffer having an input coupled to the second line, an output, and a node to receive the control signal.

5. The apparatus of claim 1, wherein the communication bus circuit lacks a pullup resistor coupled between the first line and a supply voltage.

6. An apparatus comprising:
a communication bus circuit including a clock line and a data line;
a first device coupled to the clock line and the data line; and
a second device coupled to the clock line and the data line, the second device including an active pullup device having a first tristate buffer and a second tristate buffer, the first tristate buffer having an input, an output coupled to the data line, and a node to receive a control signal, the second tristate buffer having an input coupled to the data line, an output, and a node to receive the control signal, wherein a current on the clock line is supplied entirely by the second device.

7. The apparatus of claim 6, wherein the second device includes an additional active pullup device having a third tristate buffer and a fourth tristate buffer, the third tristate buffer having an input coupled to the data line, an output, and a node to receive an additional control signal, the fourth tristate buffer having an input, an output coupled to the data line, and a node to receive the additional control signal.

8. The apparatus of claim 7, wherein the active pullup device has a first type of active control and the additional active pullup device has a second type of active control.

9. The apparatus of claim 6, wherein the second device includes a microcontroller device.

10. The apparatus of claim 9, wherein the first device includes a memory device.

11. The apparatus of claim 6, wherein the communication bus circuit lacks a pullup resistor coupled between the data line and a supply voltage.

12. An apparatus comprising:
a dual-wire communication bus circuit having a first line to carry a data signal and a second line to carry a clock signal;
a first device including a first buffer and a second buffer, the first buffer having an input, an output coupled to the first line, and a node directly coupled to a first control line, the second buffer having an input coupled to the first line, and an output, and a node directly coupled to the first control line; and
a second device including a third buffer and a fourth buffer, the third buffer having an input coupled to the first line, an output, and a node directly coupled to a second control line, the fourth buffer having an input, an output coupled to the first line, and a node directly coupled to the second control line.

13. The apparatus of claim 12, wherein the first device includes a fifth buffer having an input, an output coupled to the second line, and a node directly coupled to the first control line, and the second device includes a sixth buffer having an input coupled to the second line, an output, and a node directly coupled to the second control line.

14. The apparatus of claim 13, wherein the first device includes a seventh buffer having an input coupled to the second line, an output, and a node directly coupled to the first control line, and the second device includes an eighth buffer having an input, an output coupled to the second line, and a node directly coupled to the second control line.

15. The apparatus of claim 13, wherein the fifth and sixth buffers are configured to drive the clock signal from the first device to the second device.

16. The apparatus of claim 14, wherein the seventh and eighth buffers are configured to drive the clock signal from the second device to the first device.

17. The apparatus of claim 12, wherein the dual-wire communication bus circuit lacks a pullup resistor coupled between the first line and a supply voltage, and the dual-wire communication bus circuit lacks a pullup resistor coupled between the second line and the supply voltage.

18. An apparatus comprising:
a dual-wire communication bus having a first line to carry a data signal and a second line to carry a clock signal, wherein the dual-wire communication bus lacks a pullup resistor coupled between the first line and a supply voltage, and the dual-wire communication bus lacks a pullup resistor coupled between the second line and the supply voltage;
a first device including a first buffer and a second buffer, the first buffer having an input, an output coupled to the first line, and a node directly coupled to a first control line, the second buffer having an input, and an output coupled to the second line, and a node directly coupled to the first control line; and
a second device including a third buffer and a fourth buffer, the third buffer having an input coupled to the first line, an output, and a node directly coupled to a second control line, the fourth buffer having an input coupled to the second line, an output, and a node directly coupled to the second control line.

19. The apparatus of claim 18, wherein the first device includes a fifth buffer having an input coupled to the first line, an output, and a node directly coupled to the first control line, and the second device includes a sixth buffer having an input, an output coupled to the second line, and a node directly coupled to the second control line.

20. The apparatus of claim 19, wherein the first device includes a seventh buffer having an input coupled to the first line, and an output, and a node directly coupled to the first control line, and the second device includes an eighth buffer having an input, an output coupled to the second line, and a node directly coupled to the second control line.
